(19) United States
(12) Patent Application Publication
(10) Pub. No.: US 2015/0247488 A1
(43) Pub. Date: Sep. 3, 2015

(54) DYNAMICS OF VERTICAL AXIS WIND TURBINE

(71) Applicant: Rajagopal Raghunathan VALAGAM, (US)

(72) Inventor: Rajagopal Raghunathan Valagam, Chennai (IN)

(21) Appl. No.: 14/391,460

(22) PCT Filed: Apr. 11, 2013
(86) PCT No.: PCT/IN2013/000242

§ 371 Date: Oct. 9, 2014

(30) Foreign Application Priority Data
Apr. 12, 2012 (IN) 1481/CHE/2012

(51) Int. Cl. F03D 7/06; F03D 3/06; F03D 11/04; F03D 3/00

(52) U.S. Cl. CPC F03D 7/06; F03D 3/005; F03D 3/061; F03D 11/04

(57) ABSTRACT

The present invention includes a vertical axis wind turbine with isolator mechanism for eliminating dynamic instability caused by uneven forces. The isolating mechanism includes of a plurality of rotating isolators/vertical support, plurality of tethering devices, plurality of pair of horizontal members, plurality of pair of clamping devices. The rotating isolators are arranged close proximity to the central fixed shaft of the turbine. The plurality of clamping devices arranged around the rotating isolators and each clamping device attached with vertical blades via a tethering device, and each clamping device attached with each clamping device via horizontal members. Wherein, when the uneven wind force act on the turbine then the isolator mechanism diverts the vibration via itself to tower and thereby dynamic instability is eliminated.

### FIELD OF INVENTION

The present invention relates to a vertical axis wind turbine and particularly relates to tethering of vertical blades of a vertical axis wind turbine. More particularly, the present invention relates to tethering of vertical blades using an isolator mechanism to prevent damage to the wind turbine because of the centrifugal force built up by the rotating blades.

### DESCRIPTION OF PRIOR ART

Wind turbines are widely used to harness energy from the wind and are now capable of high performance in a variety of wind conditions. Wind turbines are of two types, horizontal axis wind turbines and vertical axis wind turbines. Vertical axis designs such as “Eggbeater” or Darrieus lift type vertical axis machines having curved blades, Giromill having straight blades and Savonius a drag-type device having scoops to catch the wind has been widely used.

Wind turbines are designed with optimal tip speed ratios to extract as much power out of the wind as possible. The ratio of the blade tip speed to the wind speed is commonly known as the tip speed ratio. Higher the tip speed ratio the more efficient is the operation of the wind machine. A drag-type machine, will produce a tip speed ratio close to one and Lift-type wind turbines have tip speed ratios in excess of one.

The vertical axis wind turbine consists of one or more vertical aerofoil blades made of metal or fiber or any light weight material arranged around a rotating axis, which is joined at the top and bottom with fixed plates or rods. The vertical blades along with the connected rods or plates rotate about the vertical axis which is connected to the turbine generator.

The typical problem of vertical axis wind turbine is the build-up of centrifugal force at high RPM of rotation of the turbine, which exerts a bending force on the blades. Due to this centrifugal force, the flexible nature of the blades tends to bend them outward in the middle, which further increases the centrifugal force effect.

As a result, the blades transfer the effects of the centrifugal force to the central axis as they are tied up or tethered or welded together with a either a rigid or flexible horizontal member. This can effect in a tilt or bending action of the vertical axis, which will result in wobbling and vibration of the wind turbine. The vibration along with the strong centrifugal force of the blades may damage the wind turbine at high speeds as they are typically bound or tethered together. To generate the optimum power, the blades should be stiff and hold its angle of attack varying angles of the wind. Flapping of the blades can be destructive to the vertical axis wind turbine.

Accordingly, there exists a need to provide means and methods of tethering of vertical blades of a vertical axis wind turbine by an isolator mechanism to avoid damage (bending, flapping or vibration) of the wind turbine due to the centrifugal force built up by the rotating blades on the central fixed shaft.

### OBJECT OF THE INVENTION

One or more of the problems/limitations of the conventional prior art may be overcome by various embodiments of the system and method of the present invention.

Accordingly, it is the primary object of the present invention to provide an isolator mechanism for tethering of blades of a vertical axis wind turbine.

It is another object of the present invention, wherein the isolator mechanism isolates the blades from the central axis of the wind mill to avoid damage to the wind turbine due to the centrifugal force built up by the rotating blades on the central axis.

It is another object of the present invention, wherein the central axis is a fixed shaft.

It is another object of the present invention, wherein the tethering of vertical blades of a vertical axis wind turbine using isolator mechanism comprising of:
One or more tethering means;
At least two vertical columns;
At least two horizontal members for each tethering of vertical blades; and
One or more clamping means

It is another object of the present invention, wherein the blades are flexible.

It is another object of the present invention, wherein the tethering means includes flexible connections.

It is another object of the present invention, wherein the flexible connection includes stainless steel, fiber glass, Kevlar.

It is another object of the present invention, wherein the tethering means is positioned at equal intervals between hub or rigid supporting members placed on top and bottom of the vertical axis wind turbine.

It is another object of the present invention, wherein the tethering means are fixed to the vertical blades on either side with a clamping means.

It is another object of the present invention, wherein the tethering means are joined to a matching metal strip flowing from the opposite direction attached to an opposing aerofoil blade through the isolator mechanism.

It is another object of the present invention, wherein the vertical column acts as a rotating isolator.

It is another object of the present invention, wherein the isolators are positioned between the two vertical blades in close proximity to the central fixed shaft such that the said vertical blades are isolated from the fixed shaft of the wind mill.

It is another object of the present invention, wherein the ends of the isolators are attached to the hub or rigid supporting members on the top and bottom of the vertical axis wind turbine.

It is another object of the present invention, wherein the isolators are flexible metal strips.

It is another object of the present invention, wherein the metal strip is stainless steel strip.

It is another object of the present invention, wherein the horizontal members are positioned in between each tethering of the vertical blades.

It is another object of the present invention, wherein the horizontal members are positioned such that the horizontal members surround the isolators by a pair of connecting means.

It is another object of the present invention, wherein the connecting means is flexible metal strips made of stainless steel or cable.

It is another object of the present invention, wherein the ends of the connecting means are connected to the ends of the horizontal members.

It is another object of the present invention, wherein the tethering means are isolated from the central fixed shaft through the connecting means that is connected through the horizontal member bounded by cables.

It is another object of the present invention, wherein the isolator mechanism thereby ensures that the central fixed shaft is not affected by the centrifugal forces acting on the vertical blades.

It is another object of the present invention, wherein the isolator mechanism thereby avoids bending or vibration of the wind turbine due to the centrifugal force built up by the rotating blades on the central fixed shaft.

It is another object of the present invention, wherein the isolator mechanism thereby reduces shear effect on the central fixed shaft and keeps the blades in their orientation.

It is another object of the present invention, wherein the isolator mechanism cancels the effect of the vibration and centrifugal forces due to the virtue of being placed on identically and diametrically opposite directions with equal number of parts and equal dimensions.

It is another object of the present invention, wherein the stainless steel strip placed with flat side face upward used for tethering reduces the wind resistance.

It is another object of the present invention, wherein the use of broad stainless steel strip for tethering avoids self-pitching or twisting of flexible blades.

It is another object of the present invention, wherein the use of flexible connections provides better tensile strength and rigidly holds the blades in their orientation.

It is another object of the present invention, wherein the tethering using isolator mechanism provides stability to the blades of vertical axis wind turbine.

It is another object of the present invention, wherein the tethering using isolator mechanism keeps the blades in their desired orientation irrespective of the various angles of attack of wind.

It is another object of the present invention, wherein the tethering using isolator mechanism eliminates dynamic instability caused by uneven forces like turbulent wind and drag due to the wind.

### SUMMARY OF THE INVENTION

The present invention discloses about a vertical axis wind turbine with isolator mechanism for eliminating dynamic instability caused by uneven forces. The isolating mechanism (5) comprises of a plurality of rotating isolators (6)/vertical support, plurality of tethering means (7), plurality of pair of horizontal members (8), plurality of pair of clamping means (9). The rotating isolators (6) are arranged close proximity to the central fixed shaft of the turbine. The plurality of clamping means (9) arranged around the rotating isolators (6) and each clamping means (9) attached with vertical blades (1) via tethering means (7), and each clamping means (9) attached with each clamping means (9) via horizontal members (8). Wherein, when the uneven wind force act on the turbine then the isolator mechanism diverts the vibration via itself to tower (2) and thereby dynamic instability is eliminated.

### BRIEF DESCRIPTION OF THE DRAWINGS

| S. NO | PART NAME | PART NO |
|---|---|---|
| 1. | Air foil blade/Vertical blade | 1 |
| 2. | Tower | 2 |
| 3. | Central fixed shaft | 3 |
| 4. | Rigid supporting members/Hub | 4 |
| 5. | Isolating mechanism | 5 |
| 6. | Rotating isolators/vertical support | 6 |
| 7. | Tethering means | 7 |
| 8. | Horizontal member | 8 |
| 9. | Clamping means | 9 |
| 10. | Flap | 10 |

FIG. 1 illustrates the tethering of vertical blades using an isolator mechanism according to the present invention.

FIG. 2 illustrates the sectional view B-B of FIG. 1.

FIG. 3 illustrates the embodiment of the isolating mechanism, which shows the plurality of rotating isolators (6) and modified arrangement of tethering means (7) in the turbine assembly. The arrangement diverts the vibration via itself to tower.

### DETAILED DESCRIPTION OF THE INVENTION

So that the manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawing illustrate only a preferred embodiment of the invention and is therefore not to be considered limiting of the invention's scope as it may admit to other equally effective embodiments.

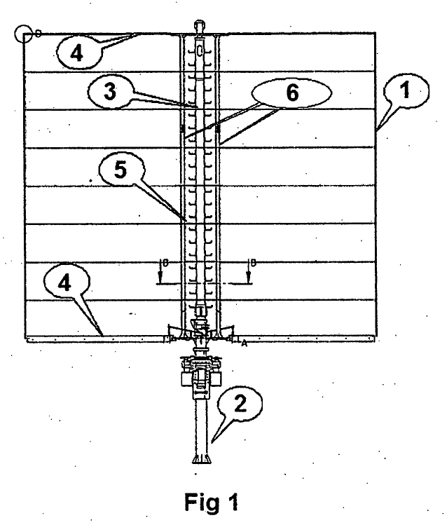

Referring to FIG. 1, the vertical wind turbine consists of one or more vertical airfoil blades (1). These blades are joined together to a hub or rigid supporting members (4) that are horizontally placed. These structural supporting members provide the necessary rigidity for the overall shape of the vertical wind turbine structure. These members also act as a hub for transmitting the rotational force of the blade to the central fixed shaft. A similar horizontal rigid member is placed on the top side of the wind turbine to support the upper portion of the turbine. The central fixed shaft (3), transfers the force of the blade (1) to the tower (2). The horizontal tethering members (7), are isolated from the central fixed shaft (3) using an isolator mechanism (5). At least two vertical columns (6), which act as rotating isolators, are positioned between the two vertical blades (1) in close proximity to the central fixed shaft (3) such that the said vertical blades (1) are isolated from the fixed shaft (3) of the windmill. The ends of the isolators are attached to the hub or rigid supporting members (4) on the top and bottom of the vertical axis wind turbine.

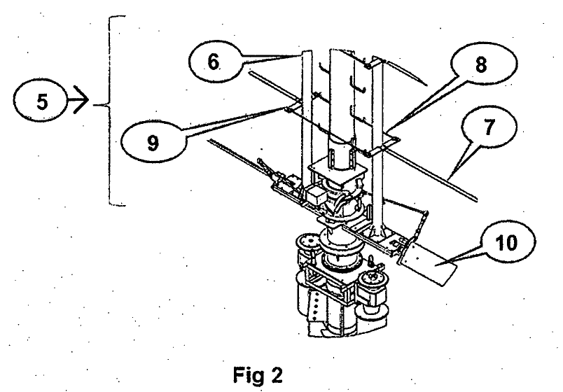

Referring to FIG. 2, the horizontal tethering means (7) is made of flexible connections of thickness ranging from 0.5-3 mm and width ranging from 40-100 mm. The tethering means (7) are fixed to the vertical blades (1) on either side with a special arrangement of clamps/clamping means (9), and flow towards the central fixed shaft (3). The tethering means are isolated from the axis through a connecting means that is connected through one or more plates bounded by cables. The connecting means is flexible metal strips made of stainless steel. The isolation arrangement in is joined around the central fixed shaft in such a way they are as to not touching each other. The isolation arrangement ensures that the centrifugal force of either of the blades is passed on to the metal strip and directed to the opposite blade. The opposing centrifugal forces cancel the effect and do not affect the central fixed shaft. As a result, the central fixed shaft remains vertical and stable without being affected by the vibration or flexing of the blades. This ensures the longevity and sturdiness of the total structure and keeps the blade in their required angle of operations at all times.

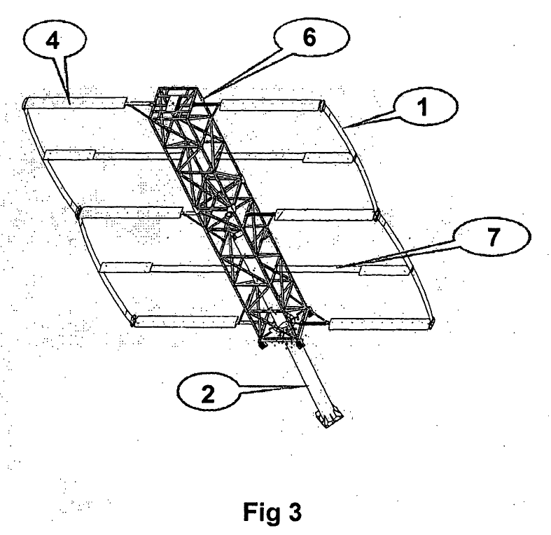

Referring to FIG. 3, embodiment of isolating mechanism comprises of plurality of rotating isolators (6) with suitable tethering means (7) arrangement for providing more stable and vibration free p. The embodiment of the invention is capable of protecting vibration created by all direction of winds and which diverts the vibration through isolating mechanism and tower.

One of the embodiments of the invention discloses about a vertical axis wind turbine with isolator mechanism for eliminating dynamic instability caused by uneven forces. The vertical axis wind turbine with isolator mechanism comprises of a tower (2), a central fixed shaft (3) mounted on the tower (2), at least a pair of rigid supporting members (4) horizontally and rotatably extended either side of a top and bottom portion of the central fixed shaft (3), one end of each top and bottom rigid supporting members (4) holds at least one vertical blade (1).

The isolating mechanism of the present invention is capable of (5) observing or diverting vibration via central fixed shaft (3) to tower (2). The isolating mechanism (5) comprises of a plurality of rotating isolators (6) vertically provided between horizontally extended rigid supporting members (4) and longitudinally arranged close proximity to the central fixed shaft (3), wherein the ends of the rotating isolators (6) are attached between rigid supporting members (4), the isolator mechanism further comprises of plurality of tethering means (7), plurality of pair of horizontal members (8), plurality of pair of clamping means (9) are provided between vertical blades (1) via the rotating isolators (6).

The plurality of clamping means (9) arranged around the rotating isolators(6) and each clamping means (9) attached with vertical blades (1) via tethering means (7), and each clamping means (9) attached with each clamping means (9) via horizontal members (8). Wherein, when the uneven wind force act on the turbine then the isolator mechanism diverts the vibration via itself to tower (2) and thereby dynamic instability is eliminated.

Another embodiment of the invention discloses about arrangement of rotating isolators, the rotating isolators (6) may have any shaped and any number of rotating isolators (6) provided between rigid horizontal members (8) and close proximity the rotating or fixed shaft. Particularly FIG. 3 clearly shows the embodiment of the invention.

Yet another embodiment of the invention discloses about a tethering means (7) which can be connected with rotating isolator directly or via clamp or any other suitable connecting means.

Yet another embodiment of the invention discloses about arrangement of isolating mechanism. In this embodiment plurality of clamping means (9) arranged along the top to bottom portion of rotating isolators (6) with tethering means (7) and horizontal members (8). In this arrangement provides more stability to wind turbine.

Further embodiment of the invention discloses about a method for eliminating dynamic instability of turbine caused by uneven forces by means of isolating mechanism (5), the steps involved in this method are first mounting a central fixed shaft (3) on the tower (2) then horizontally and rotatably extending at least a pair of rigid supporting members (4) on either side of a top and bottom portion of the central fixed shaft (3) and providing a vertical blade (1) between one end of each top and bottom rigid supporting members (4).

Steps involved in arranging an isolating mechanism (5) for observing or diverting vibration via central fixed shaft (3) and tower (2) are vertically providing a plurality of rotating isolators (6) between horizontally extended rigid supporting members (4) and longitudinally arranging close proximity to the central fixed shaft (3), and attaching the ends of the rotating isolators (6) between rigid supporting members (4).

Further arranging plurality of clamping means (9) around the rotating isolators (6) and attaching each clamping means (9) with blade (1) via tethering means (7), and attaching each clamping means (9) with each clamping means (9) via horizontal members (8). Finally configuring the isolating mechanism (5) for diverting the vibration created by uneven wind force via itself to tower (2), wherein, when the uneven wind force act on the turbine then the isolating mechanism (5) diverts and eliminates the effect of vibration on the turbine thereby dynamic instability is eliminated.

1. A vertical axis wind turbine with isolator mechanism for eliminating dynamic instability caused by uneven forces, the vertical axis wind turbine with isolator mechanism comprises of;
a tower,
a central fixed shaft mounted on the tower,
at least a pair of rigid supporting members horizontally and rotatably extended either side of a top and bottom portion of the central fixed shaft,
one end of each top and bottom rigid supporting members holds at least one vertical blade,
wherein the isolating mechanism for observing or diverting vibration via central fixed shaft to tower, the said isolating mechanism comprises of;
a plurality of rotating isolators vertically provided between horizontally extended rigid supporting members and longitudinally arranged close proximity to the central fixed shaft wherein the ends of the rotating isolators are attached between rigid supporting members, the isolator mechanism further comprises of plurality of tethering means, plurality of pair of horizontal members, plurality of pair of clamping means are provided between vertical blades via the rotating isolators,
plurality of clamping means arranged around the rotating isolators and each clamping means attached with vertical blades via tethering means, and each clamping means attached with each clamping means via horizontal members
wherein, when the uneven wind force act on the turbine then the isolator mechanism diverts the vibration via itself to tower and thereby dynamic instability is eliminated.

2. The vertical axis wind turbine with isolator mechanism as claimed in claim 1, wherein any shaped and any number of rotating isolators provided between rigid horizontal members and close proximity the rotating or fixed shaft.

3. The vertical axis wind turbine with isolator mechanism as claimed in claim 1, wherein the said tethering means connected with rotating isolator directly or via clamp or any other suitable connecting means.

4. The vertical axis wind turbine with isolator mechanism as claimed in claim 1, wherein the said plurality of clamping means arranged along the top to bottom portion of rotating isolators with tethering means and horizontal members.

5. A method for eliminating dynamic instability of turbine caused by uneven forces by means of isolating mechanism, the method comprises the steps of;
mounting a central fixed shaft on the tower,
horizontally and rotatably extending at least a pair of rigid supporting members on either side of a top and bottom portion of the central fixed shaft,
providing a vertical blade between one end of each top and bottom rigid supporting members,
further providing an isolating mechanism for observing or diverting vibration via central fixed shaft and tower,
vertically providing a plurality of rotating isolators between horizontally extended rigid supporting members and longitudinally arranging close proximity to the central fixed shaft, and attaching the ends of the rotating isolators between rigid supporting members,
arranging plurality of clamping means around the rotating isolators and attaching each clamping means with blade via tethering means, and attaching each clamping means with each clamping means via horizontal members,
configuring the isolating mechanism for diverting the vibration created by uneven wind force via itself to tower, wherein, when the uneven wind force act on the turbine then the isolating mechanism diverts and eliminates the effect of vibration on the turbine thereby dynamic instability is eliminated.

6. The method as claimed in claim 5, wherein any shaped and any number of rotating isolators provided between rigid horizontal members and close proximity the rotating or fixed shaft.

7. The vertical axis wind turbine with isolator mechanism as claimed in claim 1, wherein the said tethering means connected with rotating isolator directly or via clamp or any other suitable connecting means.

8. The vertical axis wind turbine with isolator mechanism as claimed in claim 1, wherein the said plurality of clamping means arranged along the top to bottom portion of rotating isolators with tethering means and horizontal members.
